(19) United States
(12) Patent Application Publication
(10) Pub. No.: US 2026/0318160 A1
(43) Pub. Date: Oct. 15, 2026

(54) CLAMP ASSEMBLY

(71) Applicant: MATRIX COMPOSITES & ENGINEERING LTD, Henderson, Western Australia (AU)

(72) Inventors: Narciso VILA RAMIREZ, Henderson (AU); Robert Friedrich SCHMITZ, Henderson (AU); James Francis William KINGSTON, Henderson (AU); Simon Keith BRAYSHAW, Henderson (AU)

(73) Assignee: MATRIX COMPOSITES & ENGINEERING LTD, Henderson, Western Australia (AU)

(21) Appl. No.: 19/104,520

(22) PCT Filed: Aug. 18, 2023
(86) PCT No.: PCT/AU2023/050787

§ 371 Date: Feb. 18, 2025

(30) Foreign Application Priority Data
Aug. 18, 2022 (AU) 2022902361

(51) Int. Cl. E21B 17/01; F16L 1/24

(52) U.S. Cl. CPC E21B 17/012; F16L 1/24

(57) ABSTRACT

The present invention provides a clamp assembly which is movable between a first condition wherein the clamp assembly can be fitted to or removed from a riser, and a second condition wherein the clamp assembly is secured to the riser. The clamp assembly comprises a clamping device having an inner clamping face which, in use, is adapted to engage the external surface of the riser. The clamping device also comprises a recess in an outer face. The clamp assembly further provides a fastening means received in the recess wherein the fastening means facilitates movement of the clamp assembly between the first condition and the second condition. The clamp assembly further comprises a resilient means which co-operates with the fastening means and the clamping device wherein the resilient means accommodates variations in the diameter of the inner clamping face of the clamping device when the clamp assembly is in the second condition.

### CROSS REFERENCE TO RELATED APPLICATIONS

This application is a U.S. National Phase Application under 35 U.S.C. 371 of International Application No. PCT/AU 2023/050787 filed on Aug. 18, 2023, which claims priority to Australian Patent Application No. 2022902361 filed on Aug. 18, 2022. The entire disclosures of the above applications are incorporated herein by reference.

### TECHNICAL FIELD

The present invention relates to a clamp assembly adapted to be secured to a riser. In particular, the present invention relates to a clamp assembly which is adapted to be secured to a riser located in a body of fluid, wherein one or more buoyancy devices co-operate with the clamp assembly so as to be secured to the riser, increasing the buoyancy of the riser.

### BACKGROUND

In subsea operations, one or more risers are used to convey fluids and gases between seabed assets and the surface. The risers can be in the form of flexible pipes and/or umbilical cables. They may also be of a more rigid nature such as a steel catenary riser (SCR). While the risers require a certain strength and rigidity they must also remain flexible to offset the effects of currents in the sea. As such, the risers are normally provided in the form of a multilayered pipe including an outer sleeve over one or more layers of various materials, including an internal webbing of wire. On the other hand, SCR's have a simple steel construction resulting in a much higher bending stiffness.

Risers, particularly those located in deep water, are heavy and place a large amount of tension on their supports as well as along the riser. To assist in supporting the risers, their weight is offset by securing buoyancy devices, such as buoyancy jackets, along the riser at selected locations. In order to prevent the buoyancy jackets from sliding along the riser, clamps are first attached to the riser at the selected locations before the buoyancy jackets are secured relative to the clamps. With these applications it is important that the clamps are able to exert sufficient force on the riser to prevent slippage of the clamp relative to the riser, to prevent slippage of the riser's outer sleeve relative to its internal layers, and to prevent the clamp assembly otherwise damaging the riser.

A known type of clamp assembly consists of a number of bulky C-shaped bodies joined to each other along one side by a hinge. These bodies co-operate to form a cylindrical aperture having an internal diameter corresponding to the external diameter of the riser. In use, the C-shaped bodies are positioned to encircle the riser and are then clamped to the riser, either by bolting the free ends of the clamp assembly together or by surrounding the C-shaped bodies with a compression band that is tightened.

A disadvantage of using bulky C-shaped bodies in a clamp assembly is that the clamp assembly is not easily adaptable for use on risers having different or varying diameters. Also the clamps are relatively heavy and difficult to manufacture due to the bulkiness of the C-shaped bodies.

These disadvantages have been at least partially overcome by forming an array clamp assembly from a plurality of relatively small elements. When fitting this type of clamp, the plurality of elements are assembled in a circular array around the riser. Once assembled they are supported and held together by a filament or cord (or a plurality of them). However, it has been found that such an array clamp assembly can be difficult to handle due to the large number of elements, its lack of structural definition before being mounted onto the riser, and its inherent flexibility within the compression band once fitted.

Another clamp assembly which seeks to address these disadvantages is described in International Application WO2016/025978 Clamp for a Flexible Pipe to the current applicant. This clamp assembly also comprises a large number of elements, but is configured to arrive to site in an assembled state before being fitted to the riser at the required position therealong. Once fitted to the riser, the ends of the clamp assembly are drawn together by a fastening strap. The fastening strap continues to fasten until the force exerted between the clamp assembly and the outside of the riser is sufficient to retain the clamp assembly in position. The material of the clamp assembly and the clamping force applied to the riser is carefully selected to ensure the coefficient of friction therebetween is sufficient to hold the clamp assembly in the desired position, but is not too large a force that the clamp assembly damages the riser. However, in operation there are a number of contributing factors which cause the outside diameter of the riser to vary, leading to changes in the contact force and the coefficient of friction between the clamp assembly and the riser. This compromises the engagement of the clamp assembly relative to the riser.

When deployed at depth, the hydrostatic pressure causes a reduction in the riser diameter. Also, in operation the riser is caused to flex with movement of the ocean which causes variation and/or distortion of the diameter. In addition the outside diameter can cycle between a reduced diameter when the riser is at depth or in cold water, and a larger diameter when the riser expands due to the temperature and/or pressure of the fluid passing therethrough. In those cases where the diameter reduces, the clamp assembly is prone to slipping relative to the riser, while in those cases where the diameter increases, the clamp assembly can damage the riser.

To accommodate the variability of the risers outside diameter, an elastomeric inner liner (such as natural rubber or EPDM) is positioned between the clamp assembly and the riser. When operating at low compressive levels, the elastomeric inner liner has a relatively high coefficient of friction. However, when the elastomeric inner liner is operating at levels at which it is exposed to high compressive stresses, there is a reduction of the coefficient of friction, enabling the clamp assembly to slip relative to the riser.

The preceding discussion of the background art is intended to facilitate an understanding of the present invention only. The discussion is not an acknowledgement or admission that any of the material referred to is or was part of the common general knowledge as at the priority date of the application.

### SUMMARY

It is an object of the invention to provide a clamp assembly for a riser, the clamp assembly ameliorates, mitigates or overcomes, at least one disadvantage of the prior art, or which will at least provide the industry with a practical choice.

Throughout the specification the term ‘riser’ is used to describe a flexible pipe, umbilical cable, pipe, or any other hollow elongate conduit which may be used to carry fluids, gas, communications, data or other risers, wherein the riser is located and operates in the subsea environment. Furthermore the term ‘riser’ can denote a single unitary riser, or a number of risers entwined or tied together.

The present invention provides a clamp assembly for a riser. Clamp assemblies are adapted to be secured to the outside of the riser at predetermined positions along the length of the riser. Each clamp assembly facilitates the attachment of buoyancy assemblies to the risers such that, in operation, the buoyancy assemblies support or minimize the weight of the riser. By supporting the weight of the riser each buoyancy assembly accommodates/alleviates stresses and forces within the riser. These stresses and forces increase with the length of the riser, the depth in which the riser is operating, and the materials used to form the riser.

According to a first aspect of the present invention there is provided a clamp assembly which is adapted to be fitted to an external surface of a riser, the clamp assembly is movable between a first condition wherein the clamp assembly can be fitted or removed from the riser, and a second condition wherein the clamp assembly is secured to the riser, the clamp assembly comprises:
a multi-element subassembly in an annular configuration, the multi-element subassembly provides an inner clamping face which, in use, is adapted to engage the external surface of the riser, the multi-element subassembly also provides a recess in an outer face;
a strap tensioning assembly received in the recess, the strap tensioning assembly facilitates movement of the clamp assembly between the first condition and the second condition; and
a compliant ring received in the recess, the compliant ring co-operates with the strap tensioning assembly and the multi-element subassembly wherein the compliant ring accommodates variations in the diameter of the inner clamping face of the multi-element subassembly when the clamp assembly is in the second condition.

According to a second aspect of the present invention there is provided a clamp assembly which is adapted to be fitted to an external surface of a riser, the clamp assembly is movable between a first condition wherein the clamp assembly can be fitted or removed from the riser, and a second condition wherein the clamp assembly is secured to the riser, the clamp assembly comprises:
a clamping device of annular configuration, the clamping device provides an inner clamping face which, in use, is adapted to engage the external surface of the riser, and a recess in an outer face;
a fastening means received in the recess, the fastening means facilitates movement of the clamp assembly between the first condition and the second condition; and
a resilient means which co-operates with the fastening means and the clamping device wherein the resilient means is received in the recess and accommodates variations in the diameter of the inner clamping face of the clamping device when the clamp assembly is in the second condition.

According to a third aspect of the present invention there is provided a clamp assembly which is adapted to be fitted to an external surface of a riser, the clamp assembly is movable between a first condition wherein the clamp assembly can be fitted or removed from the riser, and a second condition wherein the clamp assembly is secured to the riser, the clamp assembly comprises:
a clamping device formed from a plurality of clamp elements held in a side by side arrangement, the clamping device is annular in overall shape and provides an inner clamping face which, in use, is adapted to be adjacent the external surface of the riser, the clamping device also provides a recess in an outer face;
a fastening means received in the recess, the fastening means facilitates movement of the clamp assembly between the first condition and the second condition; and
a resilient means which co-operates with the fastening means and the clamping device wherein the resilient means is received in the recess and accommodates variations in the diameter of the inner clamping face of the clamping device when the clamp assembly is in the second condition.

Preferably the clamp assembly is releasably secured to the riser to be in the second position.

In use the inner clamping face of the clamping device may be adapted to engage the external surface of the riser.

The clamping device may have a first end spaced from a second end such that the clamping device is not a complete annulus.

The clamping device may be in the form of a multi-element subassembly.

The fastening means may be in the form of a strap tensioning assembly.

The resilient means may be in the form of a compliant ring. The compliant ring may have a first end spaced from a second end such that the compliant ring is not a complete ring. The compliant ring may be C-shaped.

Preferably the inner clamping face of the clamping device conforms to the shape of the riser when the clamp assembly is in its second condition.

Preferably the inner clamping face of the clamping device is able to accommodate changes in the diameter of the external surface of the riser.

Preferably the diameter of the inner clamping face varies in response to changes in the diameter of the external surface of the riser.

The resilient means may be positioned between the fastening means and the recess of the clamping device.

The resilient means may incorporate elastomeric material. The resilient means may comprise a plurality of layers formed from an elastomeric material.

The resilient means may be in the form of a generally circular resilient ring. Prior to assembly of the clamp assembly the resilient ring has no particular shape and may even be placed in an elongate condition.

The resilient means may take the form of a generally circular resilient ring once the clamp assembly is assembled.

The resilient ring may have a first end and a second end with a gap therebetween, such that the resilient ring is not a complete ring. The resilient ring may be C-shaped.

In an alternative embodiment, the resilient means may be in the form of a generally circular resilient ring having a first end support and a second end support, and a resilient body extending therebetween. The resilient body may be formed by a plurality of layers of elastomeric material spanning between the supports.

The first end support and second end support may be in a spaced face to face relation. The first end support may provide the first end of the resilient ring. The second end support may provide the second end of the resilient ring.

In one aspect of the invention each of the first end support and the second end support is formed from a body which provides a buttress. The body may be adapted to secure the plurality of layers of elastomeric material therebetween.

In another aspect of the invention, each of the first end support and the second end support is formed from a plurality of bodies. The plurality of bodies may be generally planar in shape and arranged in a face to face relationship extending along an axis substantially parallel to the longitudinal axis of the clamp assembly. The plurality of bodies may be secured together. The plurality of bodies may be secured together by a fastener, such as a bolt and nut, or a composite rod chemically bonded to composite end caps, passing through each of the plurality of bodies. The plurality of bodies may be adapted to secure the plurality of layers of elastomeric material whereby the elastomeric material extends between the first end support and the second end support.

In another aspect of the invention, each of the first end support and the second end support is formed from a body. The body may have a one or more clip projections extending therefrom for engagement with clip recesses in the end face of the clamping device for engagement therewith.

Each of the first end support and the second end support has a lower surface which engages the external surface of the riser when the clamp assembly is secured to the riser.

Each of the first end support and the second end support has an upper surface which supports a tensioning assembly of the fastening means. The upper surface supports the tensioning assembly as the clamp assembly moves between the first condition and the second condition.

The resilient ring may comprise an outer surface upon which the fastening means acts, and an inner surface which acts upon the clamp assembly such that the resilient ring is positioned between the fastening means and the clamp assembly.

The resilient ring may comprise an outer surface which engages the fastening means, and an inner surface which engages an outwardly facing surface of the recess of the clamp assembly such that the resilient ring is positioned between the fastening means and the clamp assembly within the recess.

The clamping device incorporates a gap therebetween wherein the gap may vary depending on whether the clamp assembly is in the first condition, the second condition or a condition therebetween. When in the first condition the gap may be sized to receive a riser therein.

The clamping device is formed from a plurality of clamp elements, including a first end clamp element and a second end clamp element. The gap of the clamping device is formed between the first end clamp element and the second end clamp element.

A bottom edge of each clamp element co-operates with the bottom edge of adjacent clamp elements to provide the inner clamping face.

Each clamp element may be U-shaped. Each clamp element may co-operate with adjacent clamp elements such that the U-shaped clamp elements co-operate to form the recess. Once assembled the clamping device incorporates sidewalls on either side of the recess, wherein the sidewalls are formed by the legs of the U-shaped clamp elements.

At least one sidewall of the clamp elements may have at least one projection extending inwardly into the recess. Some or all of the clamp elements may have a projection extending from at least one sidewall. Preferably each sidewall has one projection extending inwardly into the recess. Each projection may have a sloped surface angled inwardly towards the bottom of the recess. In use the resilient means may be located below the at least one projection. In use the fastening means may be located below the at least one projection. The at least one projections assist to retain the resilient means in place as well as keeping the resilient means in a relatively centered position.

The clamp elements are generally of the same shape. The first end clamp element and the second end clamp element and several clamp elements adjacent these end clamps, such as two or three adjacent clamps, may vary in height compared to the clamp elements therebetween (that is the legs of the U-shaped clamp elements at the ends may vary in length). The reduction in height may enable the fastening means to be fastened. In particular, the reduction in height may be required in order to allow a tensioner assembly to slide over the first end support and second end support, and to enable a tensioning tool to operate the tensioning assembly to fasten the fastening means. Having the first few clamp elements at each end of the clamping device with different heights/lengths provides clearance for other tools and/or components. For instance the first two clamp elements at each end may have different heights/length (i.e. different leg lengths) to each other, as well as the other clamp elements.

Engagement means may be located between adjacent clamp elements to movably interconnect adjacent clamp elements. As the clamp elements are movable relative to each other the clamping device is able to move, enabling the clamp assembly to move between its first condition wherein the clamp assembly may be fitted or removed from the riser, and its second condition wherein the diameter of the clamp, and in particular that of the inner clamping face of the clamping device, is reduced to releasably secure the clamp assembly to the riser.

The fastening means may comprise a ring clamp wherein the ring clamp can be operatively caused to reduce or increase in diameter. Whereupon reduction of the ring clamp's diameter the clamp assembly is caused to move to its second condition. Whereupon increasing the ring clamp's diameter the clamp assembly is able to move to its first condition.

Alternatively, the fastening means may comprise a strap tensioning assembly.

The clamp assembly may comprise a support device adapted to support the resilient means in a substantially central position of the recess. The support means ensures the resilient means remains in a substantially central position regardless of the orientation of the clamping assembly. The support device may comprise a resiliently deformable material located in the recess. The support device may be located between the resilient means and the sidewall. The support device may be located below the projections extending from the sidewalls. The support device may be in the form of an annular ring located either side of the resilient means.

The resilient means may have flexible extensions extending outwardly from the upper portion of the resilient means. The flexible extensions may be located below the projections extending from the sidewalls.

According to a fourth aspect of the present invention there is provided a clamp assembly movable between a first condition wherein the clamp assembly is in an expanded condition, and a second condition wherein the clamp assembly is in a reduced condition whereupon the diameter of the clamp assembly is smaller in the second condition than when the clamp assembly is in the first condition; the clamp assembly comprises:
a clamping device of circular configuration and incorporating at least one circumferential gap, the clamping device provides an inner clamping face adapted to engage an external surface of a riser, and an outwardly facing recess;
a fastening means received in the recess, the fastening means enables movement of the clamp assembly between the first condition and the second condition; and
a resilient means which co-operates with the fastening means and the clamping device wherein the resilient means is received in the recess and accommodates variations in the diameter of the inner clamping face of the clamping device.

Preferably as the resilient means accommodates variations in the diameter of the inner clamping face of the clamping device, the fastening means remains unchanged. Preferably as the resilient means accommodates variations in the diameter of the inner clamping face of the clamping device, the diameter of the fastening means remains unchanged.

Preferably the inner clamping face has a circumferential gap therein. The inner clamping face may engage a portion of the circumference of the external surface of the riser once fitted thereto.

The fastening means may be in the form of a ring clamp.

The resilient means may be in the form of a resilient elongate element which is received in the recess of the clamping device.

The resilient elongate element may be positioned between an outwardly facing surface of the recess and the ring clamp. Once in place the resilient elongate element may be circular in shape.

According to a fifth aspect of the present invention there is provided a clamp assembly for a riser, the clamp assembly having a longitudinal axis arranged to extend along the length of the flexible pipe and a radial axis being perpendicular to the longitudinal axis, the clamp assembly comprising:
a plurality of separate clamp elements being supported together in a circular array extending at least partially around the longitudinal axis, when supported together the plurality of separate clamp elements define an outwardly facing recess;
engagement means located between adjacent clamp elements to movably interconnect the clamp elements;
a strap adapted to be received in the recess to surround the clamp elements, in use for exerting a compressive force thereon, and
a resilient means which co-operates with the strap and the plurality of clamp elements wherein the resilient means is received in the recess and accommodates variations in the movement of the clamp elements relative to the strap.

Each clamp element may be wedge shaped in end view.

The wedge shape may extend through a radial arc of between 5 °to 20 °.

The wedge shape may extend through a radial arc of substantially 8 °.

Each clamp element may have a bottom edge adapted to engage the flexible pipe, the bottom edge may be concave, convex or planar.

Each clamp element may include opposed lateral faces, wherein the engagement means includes corresponding plug and socket formations provided on each of the lateral faces. The plug and socket formations may be integrally formed on each of the lateral faces. The plug and socket formations may be arranged to permit pivoting movement between adjacent clamp elements around the longitudinal axis. The clamp assembly may include spacer cushions provided between adjacent clamp elements. The cushions may be resiliently deformable. The cushions may be joined to or integrally formed with the clamp elements. A number of discrete cushions may be provided, wherein the cushions radially straddle the engagement means.

The engagement means of the clamping element may comprise complementary features which engage complementary features in adjacent clamp elements to locate the clamp elements, wherein adjacent clamp elements are limited in movement relative to each other in a direction parallel to their longitudinal plane.

The clamp elements may be supported together by being mounted on at least one filament. Each clamp element may include a transverse passage for receiving the filament. The passage may extend through the engagement means.

Each clamp element may include at least two transverse passages either side of the clamp element. The clamp element may provide a cleat for gripping the filament once it has passed through the transverse passage. The cleat may comprise a series of teeth which frictionally engage the filament once placed therein. The cleat is of particular assistance during assembly of the clamping device, allowing the filament to be gripped and held in place as successive clamping elements are assembled. It may also assist in tensioning the clamping device once assembled.

According to a further aspect of the present invention there is provided a clamp assembly, the clamp assembly is movable between a first condition wherein the clamp assembly can be fitted to or removed from a riser, and a second condition wherein the clamp assembly is secured to the riser, the clamp assembly comprises:
a clamping device having an inner clamping face which, in use, is adapted to engage the external surface of the riser, and a recess in an outer face;
a fastening means received in the recess, the fastening means facilitates movement of the clamp assembly between the first condition and the second condition; and
a resilient means which co-operates with the fastening means and the clamping device wherein the resilient means is received in the recess and accommodates variations in the diameter of the inner clamping face of the clamping device when the clamp assembly is in the second condition.

The fastening means may comprise an adjustable fastening apparatus.

The fastening means may be flexible.

The fastening means may be in the form of a flexible elongate element.

The fastening means may be in the form of a belt wherein the two ends may be adjustably fastened relative to each other.

The fastening means may be in the form of a cable wherein the two ends may be adjustably fastened relative to each other.

The fastening means may be in the form of a band wherein the two ends may be adjustably fastened relative to each other.

The fastening means may be in the form of a hoop having a break therein, wherein the two ends may be adjustably fastened relative to each other.

The fastening means may be in the form of a strap wherein the two ends may be adjustably fastened relative to each other. The strap may be a tension strap.

The fastening means may be in the form of a ring clamp wherein the two ends may be adjustably fastened relative to each other.

The fastening means may be in the form of a strap tensioning assembly wherein the two ends may be adjustably fastened relative to each other.

In each case, the two ends may be fastened together such there is a gap therebetween, or the two ends may overlap.

The resilient means may be formed form a resilient material.

The resilient means may be in the form of a circular resilient ring.

The resilient means may be in the form of a compliant ring.

The resilient means may comprise a plurality of layers, wherein each end of each layer is fixed relative to the respective end of an adjacent layer.

The resilient means may be flexible.

The resilient means may be in the form of a flexible elongate element.

The resilient means may be in the form of a belt, a cable, a band, or a strap.

The resilient means may have two ends such that once assembled the two ends are spaced from each other.

According to a further aspect of the present invention there is provided a clamp assembly, the clamp assembly is movable between a first condition wherein the clamp assembly can be fitted to or removed from a riser, and a second condition wherein the clamp assembly is secured to the riser, the clamp assembly comprises:
a clamping device having an inner clamping face which, in use, is adapted to engage the external surface of the riser, and a recess in an outer face;
a ring clamp received in the recess, the ring clamp facilitates movement of the clamp assembly between the first condition and the second condition; and
a circular resilient ring received in the recess which co-operates with the ring clamp and the clamping device wherein the circular resilient ring accommodates variations in the diameter of the inner clamping face of the clamping device when the clamp assembly is in the second condition.

The resilient means may be positioned in the recess between the fastening means and the clamping device.

According to a further aspect of the present invention, there is provided a buoyancy assembly adapted to be fitted to a riser to assist in supporting the riser, the buoyancy assembly comprising a clamp assembly as herein described.

According to a further aspect of the present invention, there is provided a riser or a riser section, the riser having at least one clamp assembly as herein described secured thereto.

### BRIEF DESCRIPTION OF DRAWINGS

Further features of the present invention are more fully described in the following description of non-limiting embodiments thereof. This description is included solely for the purposes of exemplifying the present invention. It should not be understood as a restriction on the broad summary, disclosure or description of the invention as set out herein. The description will be made with reference to the accompanying drawings in which:

FIG. 1 is a schematic view of a riser extending between a vessel located on the ocean's surface and the seabed, wherein the riser has a plurality of buoyancy assemblies secured therealong;

FIG. 2 is a perspective view of one of the buoyancy assemblies shown in FIG. 1 secured to a section of the riser;

FIG. 3 is an exploded view of the buoyancy assembly of FIG. 2 showing a clamp assembly according to a first embodiment of the present invention;

FIG. 4 is a cross sectional view of the buoyancy assembly of FIG. 2 taken along its longitudinal axis;

FIG. 5 is a cross sectional view of the buoyancy assembly of FIG. 2 taken through a central plane transverse to the longitudinal axis;

FIG. 6 is a perspective view of a clamp assembly according to the first embodiment of the invention, the clamp assembly forming part of the buoyancy assembly shown in FIG. 2;

FIG. 7 is a front view of the clamp assembly of FIG. 6;

FIG. 8 is an end view of the clamp assembly of FIG. 6;

FIG. 9 is a plan view of the clamp assembly of FIG. 6;

FIG. 10 is a bottom view of the clamp assembly of FIG. 6;

FIG. 11 is a cross sectional view of FIG. 6;

FIG. 12 is a cross sectional view of FIG. 7;

FIG. 13 is a cross sectional perspective view of FIG. 8;

FIG. 14 is a perspective view of a clamping device of the clamp assembly of FIG. 6;

FIG. 15 is a perspective view of a resilient ring of the clamp assembly of FIG. 6;

FIG. 16 is a perspective view of a clamp assembly ring of the clamp assembly of FIG. 6;

FIG. 17 is a perspective view of the resilient ring of FIG. 15 and the clamp assembly ring of FIG. 16 in combination.

FIG. 18 is a perspective view of a clamp element of the clamp assembly of FIG. 6;

FIG. 19 is a front view of the clamp element of FIG. 18;

FIG. 20 is a perspective view of an alternative end support of a resilient ring of the clamp assembly of FIG. 6;

FIG. 21 is a perspective view of the clamp assembly of FIG. 6 being fitted to a riser, wherein a tensioning assembly is securing the clamp assembly;

FIG. 22 is a perspective view of a clamp assembly according to a second embodiment of the present invention;

FIG. 23 is a front view of the clamp assembly of FIG. 22;

FIG. 24 is an end view of the clamp assembly of FIG. 22;

FIG. 25 is a plan view of the clamp assembly of FIG. 22;

FIG. 26 is a bottom view of the clamp assembly of FIG. 22;

FIG. 27 is a cross sectional view of FIG. 22;

FIG. 28 is a cross sectional view of FIG. 23;

FIG. 29 is a cross sectional perspective view of FIG. 24;

FIG. 30 is a plan view of a clamping device of the clamp assembly of FIG. 22;

FIG. 31 is a cross sectional view of the clamping device shown in FIG. 30;

FIG. 32 is a perspective view of a clamping device and support device of the clamp assembly of FIG. 22;

FIG. 33 is a close up view of one end of the clamping assembly of FIG. 22 with two clamp elements removed to show the support device;

FIG. 34 is cross sectional view of the clamp device of the clamp assembly of FIG. 22 taken between adjacent clamp elements showing the support device;

FIG. 35 is cross sectional view of the clamp device of the clamp assembly of FIG. 22 taken between adjacent clamp elements showing the support device, and a resilient ring;

FIG. 36 is cross sectional view of the clamp device of the clamp assembly of FIG. 22 taken between adjacent clamp elements showing the support device, a resilient ring and a clamp assembly ring;

FIG. 37 is a perspective view of a clamp element of the clamp assembly of FIG. 22;

FIG. 38 is a front view of the clamp element of FIG. 37;

FIG. 39 is a perspective view of a clamp element of the clamp device of the clamp assembly of FIG. 22, the clamp element being at the end of the clamp device; and

FIG. 40 is a perspective view of an end support of the resilient ring of the clamp assembly of FIG. 22.

In the drawings like structures are referred to by like numerals throughout the several views. The drawings shown are not necessarily to scale, with emphasis instead generally being placed upon illustrating the principles of the present invention.

### DETAILED DESCRIPTION

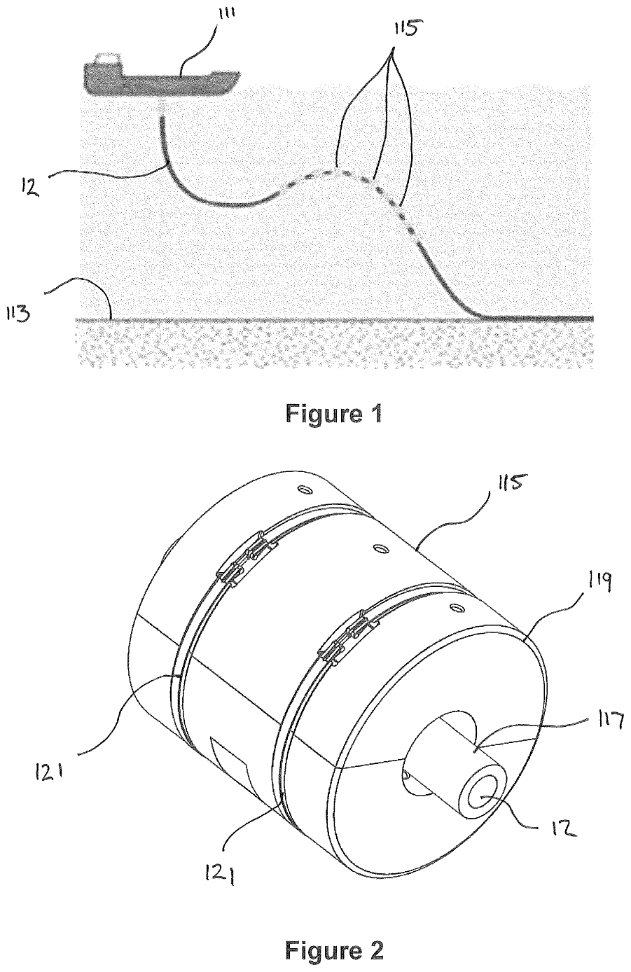

Referring to FIG. 1, in subsea environments, risers 12 extend between operations at the ocean surface, typically a vessel 111, or a rig, and assets on the seabed 113. To support the riser 12 a plurality of buoyancy assemblies 115 are fitted along the riser 12 at spaced apart positions.

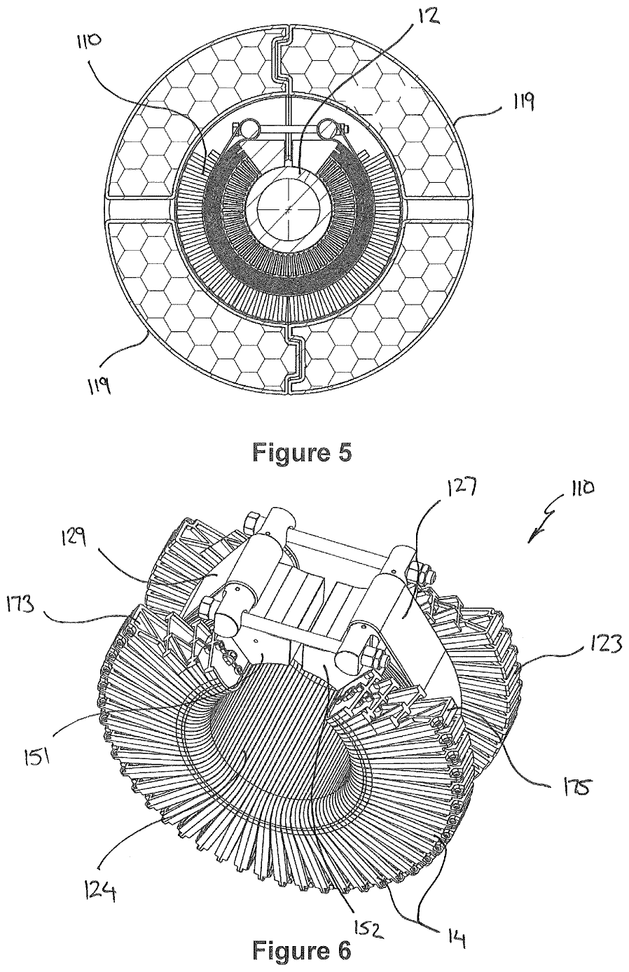

Referring to FIGS. 2 to 5, each buoyancy assembly 115 comprises a clamp assembly 110 which is secured to an external surface 117 of the riser 12, and two buoyancy elements 119. Once the clamp assembly 110 is secured to the riser 12 the buoyancy elements 119 are placed over and co-operate with the clamp assembly 110 to hold the buoyancy elements 119 relative to the riser 12. The buoyancy elements 119 are then further secured with the use of two securing straps 121. The present invention is directed to the clamp assembly 110.

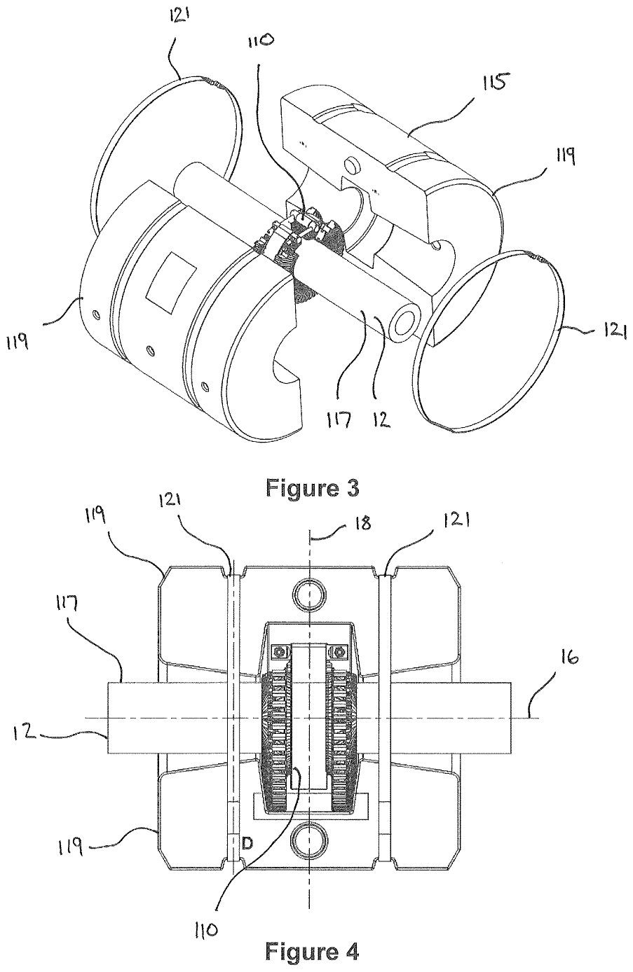

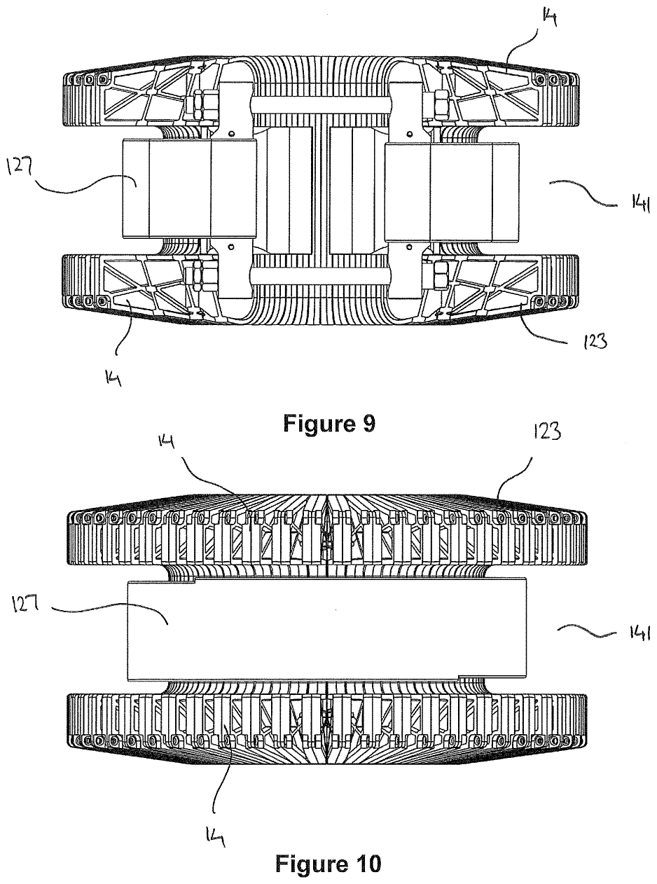

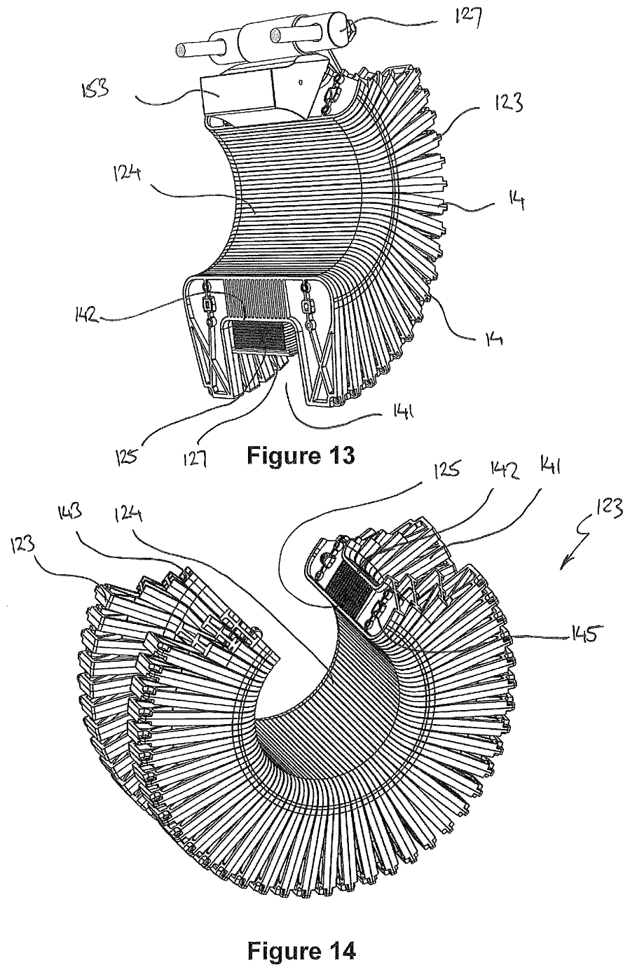

According to a first embodiment of the present invention the clamp assembly 110 is provided, as shown in FIGS. 3 to 13. The clamp assembly 110 is movable between a first condition wherein the clamp assembly can be fitted or removed from the riser 12, and a second condition wherein the clamp assembly 110 is releasably secured to external surface 117 of a section of the riser 12, as best shown in FIG. 3.

The clamp assembly 110 has a longitudinal axis 16 arranged to extend, in use, along the length of the riser 12 and further has a radial axis 18 generally perpendicular to the risers' longitudinal axis and generally coinciding with the risers' radial axis.

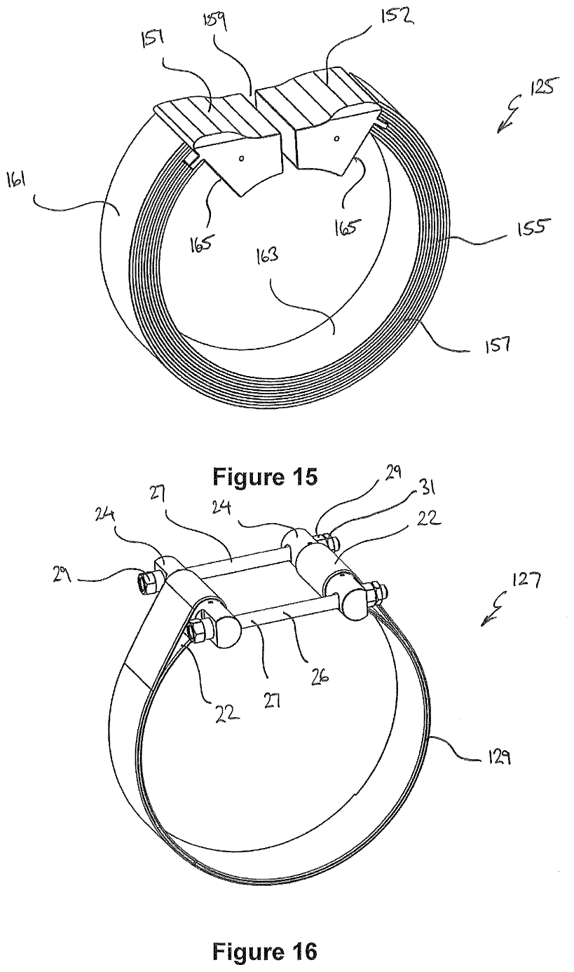

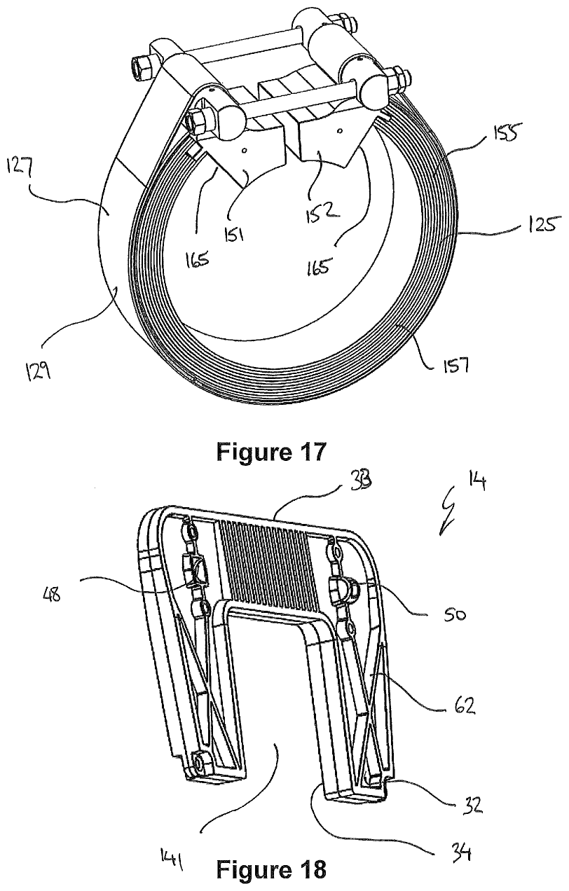

The clamp assembly 110 comprises a clamping device 123, as shown for example in FIG. 14, a resilient means in the form of a circular resilient ring 125, as shown for example in FIG. 15, and a fastening means in the form of a tension strap/ring clamp 127, as shown for example in FIG. 16.

The clamping device 123 is of an annular ring configuration.

The clamping device 123 provides an inner clamping face 124 which, in use, is adapted to engage the external surface 117 of the riser 12.

The clamping device 123 also provides a recess 141 with an outwardly facing surface 142. As will be explained below, the recess 141 receives the circular resilient ring 125 and the ring clamp 127.

The clamping device 123 is formed from a plurality of clamp elements 14 which are arranged in a face to face manner.

Referring in particular to FIGS. 18 and 19, there is shown one of the plurality of clamp elements 14. Each clamp element 14 is generally U-shaped which, when adjacent clamp elements 14 are in face to face arrangement, collectively form the recess 141. Each clamp element 14 has a bottom edge 33, whereby bottom edges 33 of adjacent clamp elements 14 cooperate to form the inner clamping face 124 which, in use, abuts the riser 12.

Each clamp element 14 is wedge shaped, when seen in end view, with the bottom edge 33 providing the narrowest width.

The bottom edge 33 can be shaped to be concave, convex or planar, the selection of the appropriate shape being dependent on the specific application for the clamp assembly 110 and the amount of pressure required to be applied to the riser 12.

The clamp element 14 further has two lateral faces 32, 34.

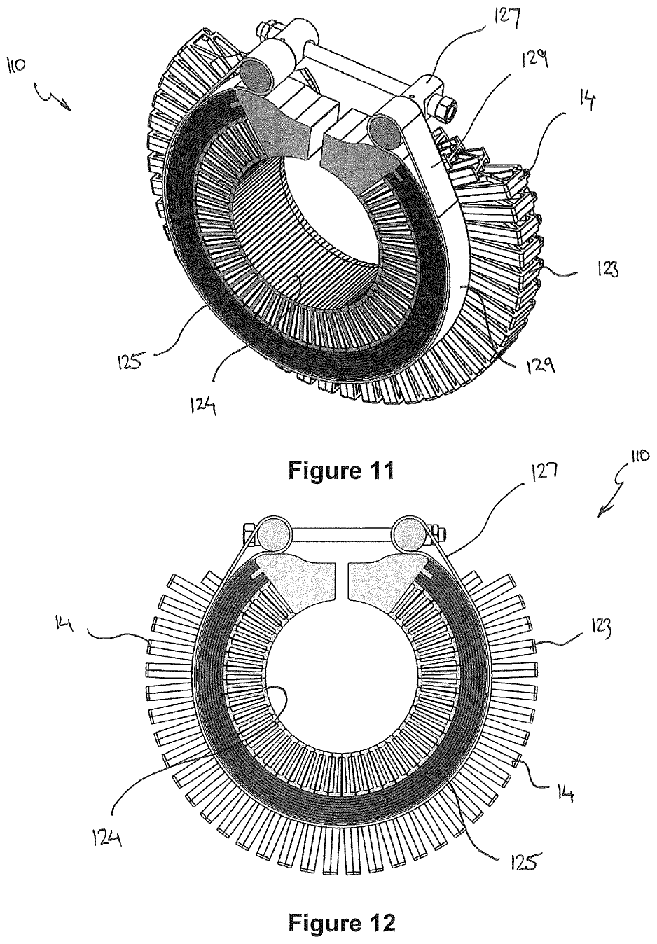

As best shown in FIGS. 11 and 16 the ring clamp 127 comprises an elongate strap 129 having opposed looped ends 22. The ring clamp 127 also comprises two crossbars 24, each which pass through a respective looped end 22. The crossbars 24 project beyond the elongate strap 129 and are joined to each other via their projecting ends by fasteners 26, comprising threaded bars 27 and nuts 29. In use, the crossbars 24 are drawn towards each other to tighten the elongate strap 129 around the clamp elements 14, causing the clamp assembly 110 to move from its first condition towards its second condition. When the clamp assembly 110 is fitted to the riser 12, tightening of the elongate strap 129 increases the compressive force exerted by the clamping device 123 on the riser 12. Once the predetermined force has been reached, lock nuts 31 are secured to the fasteners 26 to ensure the force exerted by the ring clamp 127 is maintained.

The resilient ring 125 has a first end support 151 and a second end support 152, and a resilient body 155 extending therebetween. The first end support 151 and second end support 152 are in a spaced face to face relation such that a gap 159 is formed therebetween. The resilient body 155 is in the form of a plurality of layers of elastomeric material 157 spanning between the end supports 151, 152.

The first end support 151 and the second end support 152 have a lower surface 153 which engages the external surface 117 of the riser 12 when the clamp assembly 110 is secured to the riser 12.

The first end support 151 and the second end support 152 has an upper surface 154 which supports the crossbars 24. The crossbars 24 slide across the upper surface 154 as the clamp assembly 110 moves between the first condition and the second condition.

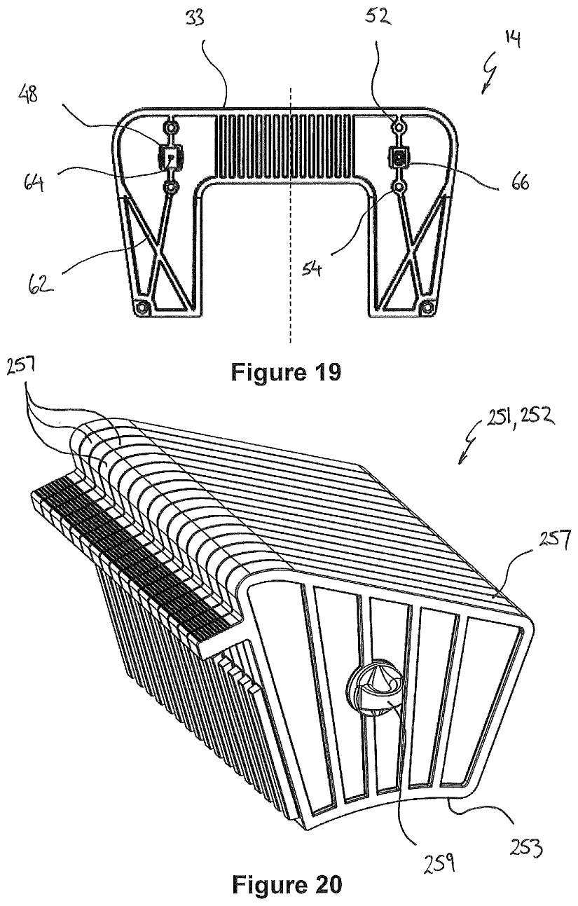

A variation of a first end support 251 and a second end support 252 is shown in FIG. 20. In this variation, each of the first end support 251 and the second end support 252 is formed from a plurality of planar bodies 257. The plurality of bodies 257 are arranged in a face to face relationship extending along an axis substantially parallel to the longitudinal axis of the clamp assembly 110. The plurality of bodies 257 are secured together by a fastener 259 passing through each of the plurality of bodies 257. The plurality of bodies secure the plurality of layers of elastomeric material 157 whereby the elastomeric material extends between the first end support 251 and the second end support 252. The first end support 251 and the second end support 252 have a lower surface 253 which engages the external surface 117 of the riser 12 when the clamp assembly 110 is secured to the riser 12, and an upper surface 254 for supporting the crossbars 24.

The resilient ring 125 provides an outer surface 161 upon which the ring clamp 127 acts, and an inner surface 163 which acts upon the outwardly facing surface 142 of the recess 141 such that the resilient ring 125 is positioned between the ring clamp 127 and the recess 141 of the clamping device 123.

When the clamp assembly 110 is fitted to the riser 12, tightening of the elongate strap 129 of the ring clamp 127 increases the compressive force, via the resilient ring 125, exerted by the clamping device 123 on the riser 12.

In the view of the position of the resilient ring 125 within the clamp assembly 110 relative to the riser 12, the resilient ring 125 is able to enhance the compliance of the clamp assembly 110 with the riser 12, without compromising the coefficient of friction acting between the inner clamping face 124 of the clamping device 123 and the external surface 117 of the riser 12. The resilient ring 125 accommodates changes in the diameter of the inner clamping face 124, which are caused by changes in the outside diameter of the riser 12.

Referring to FIGS. 18 and 19 each clamp element 14 further includes a plug 48 and socket 50 provided integrally formed with each of the lateral faces 32 and 34. The plug 48 and socket 50 are complimentary in shape and are equidistantly spaced from both the bottom edge 33 and the radial axis 18. Thus, the plug 48 on the lateral face 32 is aligned opposite to the socket 50 on the lateral face 34 of the adjacent clamp element 14.

When the clamp assembly 110 is assembled, the plug 48 of one clamp element 14 is received into and engages with the socket 50 of the adjacent clamp element 14, and vice versa, so as to interconnect adjacent clamp elements 14.

Each clamp element 14 includes two spacer cushions 52, 54 respectively on each lateral faces 32, 34 with the cushions standing proud of the lateral faces 32, 34. The cushions 52, 54 space the neighboring clamp elements 14 slightly apart from each other.

The cushions 52, 54 are preferably made from a resiliently compressible material.

It is envisaged that the clamp elements 14 will be made from a composite thermoplastic material by injection molding. It is further envisaged that the cushions 52, 54 could be molded together with the clamp elements 14 in a two-stage injection molding process.

To avoid warping of the plastics material during the manufacturing process, the clamp elements 14 should preferably have a body thickness of less than 10 mm. However, such a thin body thickness reduces the structural rigidity of the clamp elements 14 and limits the amount of compression force that they can withstand, in use, being applied by the ring clamp 127 before being crushed. Thus, a number of strengthening ribs 62 are provided on each lateral face 32, 34.

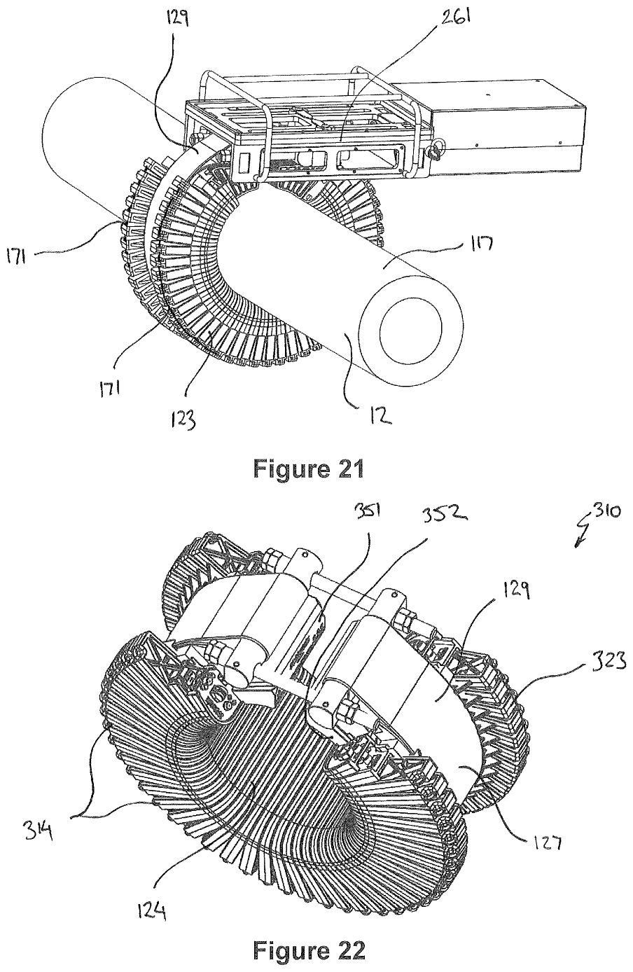

The clamp element 14 has two passages 64, 66 (see FIG. 19), one each extending centrally through the plug 48 and the socket 50 through an internal filament(s) (not shown) can be threaded to assemble the clamp assembly 110. The internal filaments are tied off onto the first end clamp element 143 and the second end clamp element 145 at each end of the clamping device 123. As best shown in FIG. 21, the clamp assembly also comprises secondary filaments 171 which pass through the legs of the U-shaped clamp elements 14 on either side of the recess 141. The secondary filaments 171 are tied off onto the first full sized clamp element 173 from the first end clamp element 143 and the first full sized clamp element 175 from the second end clamp element 145 at each end of the clamping device 123.

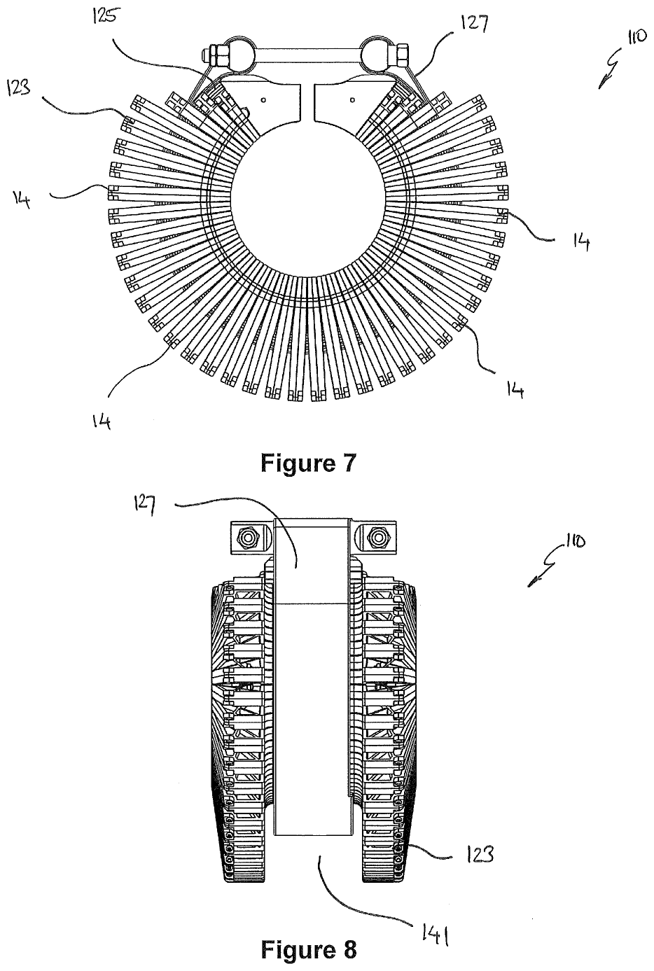

Advantageously, the first end support 151 and the second end support 152 of the circular resilient ring 125, as best shown in FIGS. 7 and 12 assist in preserving the radial alignment of clamp elements 14. In this way the clamp elements 14 can be retained in the circular form of the assembled clamp assembly 110 with their plugs 48 and sockets 50 loosely interconnecting when in the first condition (i.e. before mounting on the riser 12).

The clamp elements 14 co-operate with the resilient ring 125 to retain the clamp elements in a circular arrangement. In particular, an engaging surface 165 of each of the first end support 151 and the second end support 152 engage respectively the first end clamp element 145 and the second end clamp element 145, as best shown in FIGS. 11 and 12.

Fitting the clamp assembly 110 to the riser 12 is preferably conducted in the workshop but can also be completed on site. Due to the flexible nature of the clamp device 123, the space between the first end clamp element 143 and second end element 145 can be increased to allow the clamp device 110 to be fitted around the riser 12. The circular resilient ring 125 and the elongate strap 129 of the ring clamp 127 can then be received in the recess 141 of the clamping device 123. The cross bars 24 are then placed through the looped ends 22 of the elongate strap 129 before threaded bars 27 and nuts 29 are fitted between the crossbars 24 to hold the ends together.

As shown in FIG. 21, a tensioning tool 261 is then placed over the tensioning assembly and causes the space between the first end clamp element 143 and second end clamp element 145 to reduce, drawing the cross bars 24 towards each other, and tightening the threaded bars 27 and nuts 29, during which the clamping assembly 110 moves from the first condition to the second condition.

Following the mounting of the clamp assembly 110 onto the riser 12, the ring clamp 127 is tightened, reducing the diameter of the clamp assembly 110 and moving the clamp assembly 110 to the second condition. In the second condition the clamp assembly 110 is releasably secured to the riser 12.

The clamp assembly 110 incorporates the circular resilient ring 125 formed from elastomeric layers which is positioned between the ring clamp 127 and the clamping device 123, as opposed to the prior art which positions an elastomeric inner liner between the riser and the clamp.

As the material used for the clamp assembly 110 has a quasi-constant coefficient of friction along with a very low sensitivity to compression stress, regardless of the pressure applied, it allows a designer to predict, and therefore design the clamp assembly 110 to maintain, a more reliable holding axial force.

Also, as a result of the physical properties of the elastomeric inner liner, whereby more compression/pressure results in a reduction in the coefficient of friction, the greater tensioning force applied by the ring clamp 127 the less coefficient of friction affects the capstan effect. This results in improved clamping efficiency.

Considering that elastomers have limited resistance to heat, another advantage over the prior art approach is that the circular resilient ring 125 is not in direct contact with the riser. As a result, changes in the temperature of any fluid passing through the riser 12 has no bearing on the performance of the resilient ring 125. As it is only the clamping device 123 which is in contact with the riser 12, and as the clamping device 123 does not require to be made from resilient materials, the clamping device 123 can be formed from a material which can withstand the range of temperatures which may be experienced through the riser 12.

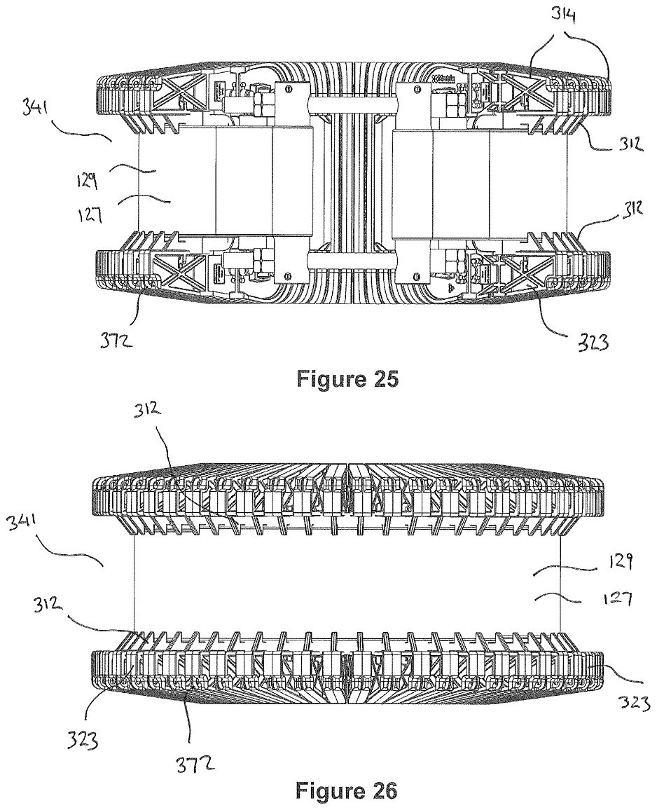

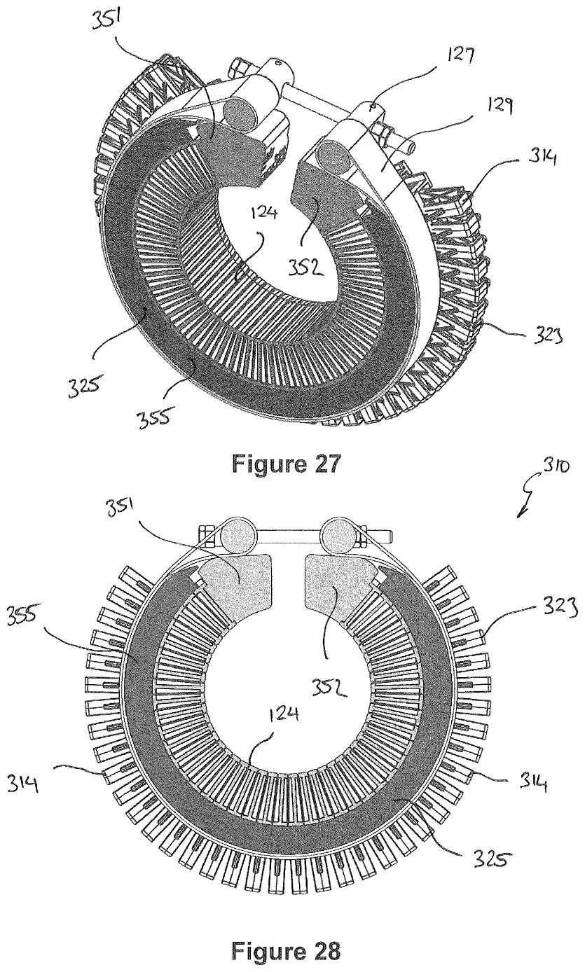

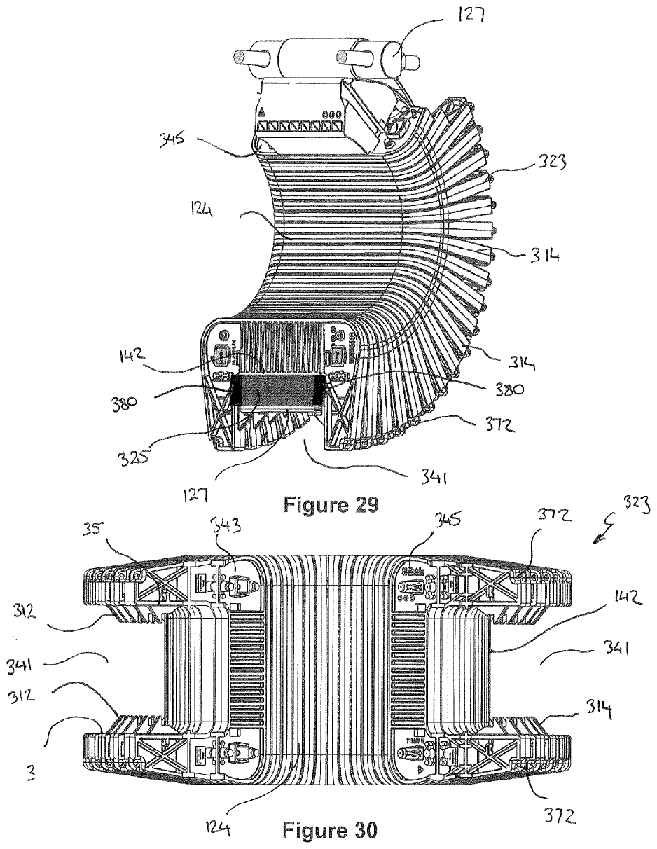

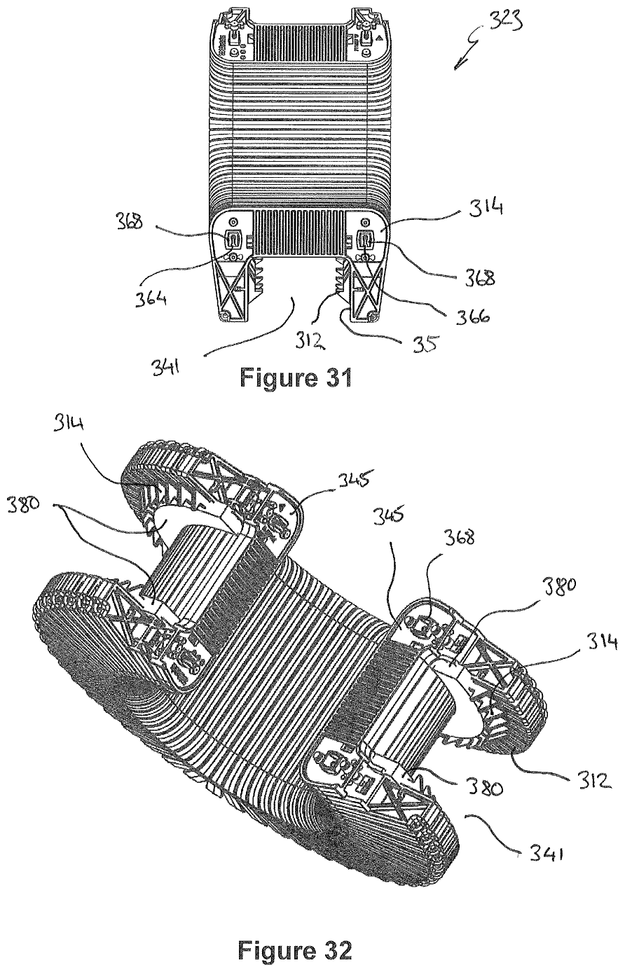

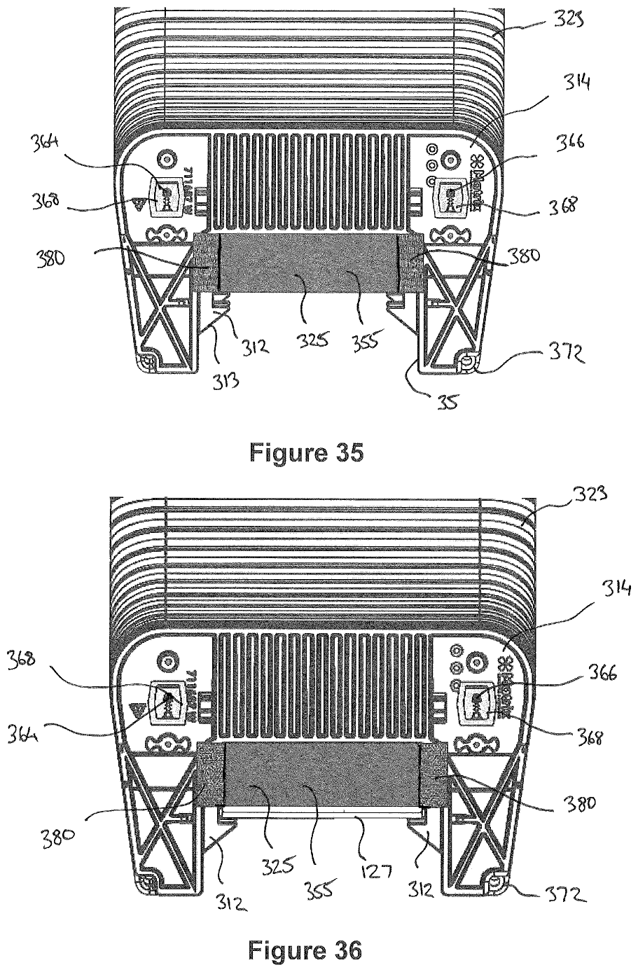

A clamp assembly 310 according to a second embodiment of the invention is illustrated in FIGS. 22 to 40. For convenience features of the clamp assembly 310 that are similar or correspond to features of the clamp assembly 110 of the first embodiment have been referenced with the same reference numerals.

The clamp assembly 310 of the second embodiment operates in substantially the same manner as the clamp assembly 110 of the first embodiment. The clamp assembly 310 of the second embodiment has several additional features which improve the operation of the clamp assembly 110 of the first embodiment as well as assist in the assembly process.

The clamp assembly 310 comprises a clamping device 323, as shown for example in FIG. 30, a resilient means in the form of a circular resilient ring 325, and a fastening means in the form of a tension strap or a ring clamp 127.

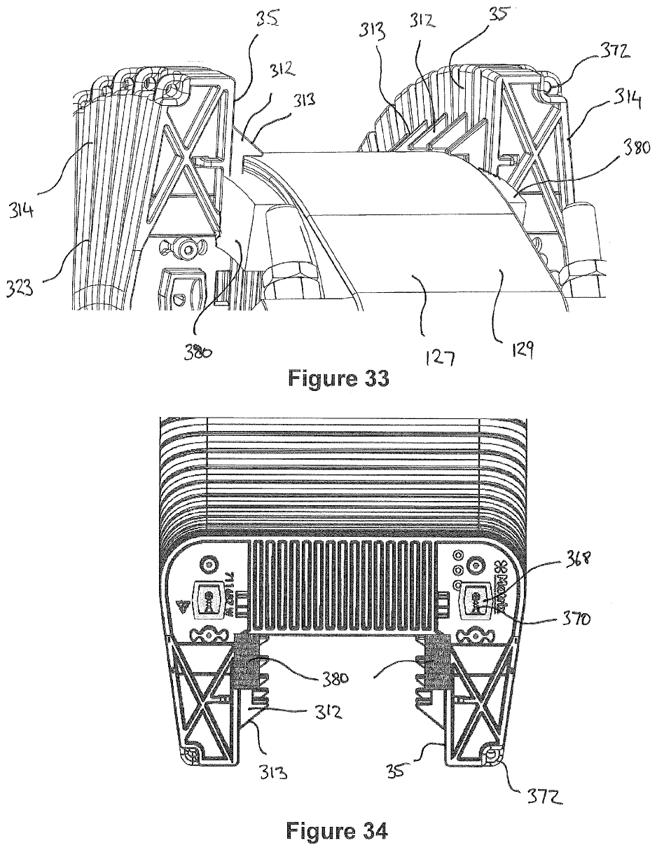

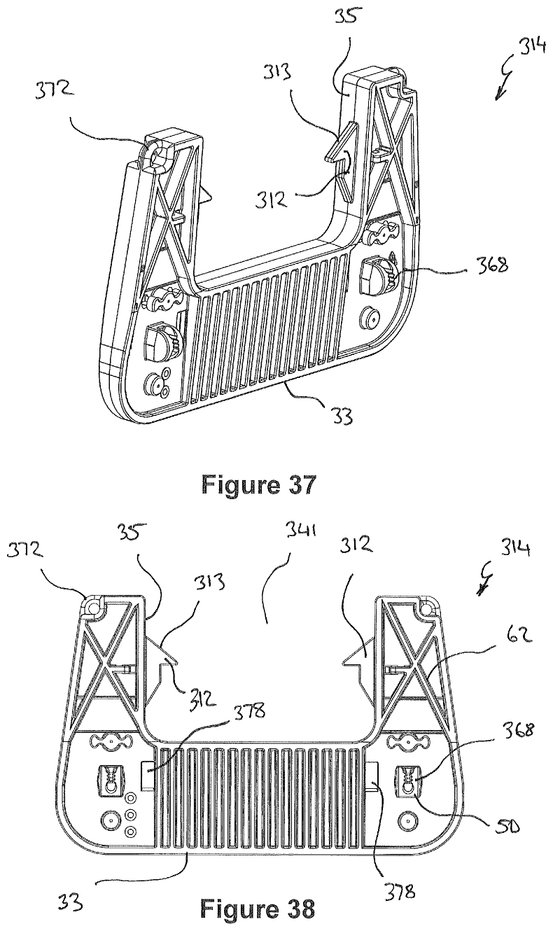

Referring particularly to FIGS. 37 and 38, each clamp element 14 provides two sidewalls 35 to define a recess 341. Each sidewall 35 provides a projection 312 extending inwardly into the recess 341 therefrom. Each projection 312 has a sloped surface 313 angled inwardly towards the bottom of the recess 341. In use the resilient ring 325 and ring clamp 127 are located below the projections, as best shown in FIGS. 33 and 36. The projection assists to retain the resilient ring 325 and ring clamp 127 in place as well as keeping the resilient ring 325 and ring clamp 127 in a relatively centered position.

The sloped surface 313 of each projection 314 facilitates passage of the resilient ring 325 and/or the ring clamp 127 in the recess 341 during assembly, if required.

While the present embodiment has projections 314 extending from each sidewall 35 of each full sized clamp element 314, other embodiments may have the projections on a portion of the full sized clamp elements 314 rather than every full sized clamp element 314.

As with the first embodiment, each clamp element 314 of the clamp device 323 of the clamp assembly 310 has two transverse passages 364, 366 (see FIGS. 37 and 38). Each of these passages 364, 366 allow for a first filament (not shown) to be threaded therethrough during assembly of the clamp assembly 310. The first filaments are tied off onto a first end clamp element 343 and a second end clamp element 345 at each end of the clamping device 323.

Each transverse passage 364, 366 of each clamp element 314 provides a cleat 368 for gripping the first filament once it has passed through the transverse passage 364, 366. Each cleat 368 comprises a series of teeth 370 which frictionally engage the first filament once it has passed through its respective transverse passage 364, 366 and placed in the cleat 370. The cleat 370 is of particular assistance during assembly of the clamping device, allowing the first filament to be gripped and held in place as successive clamping elements 314 are assembled.

The clamp assembly 310 also comprises secondary filaments (not shown) which pass through eyelets 372 at each end of the legs of the U-shaped clamp elements 314 on either side of the recess 341. The secondary filaments 371 are tied off at each end of the clamping device 123.

As with the first embodiment, the resilient ring 325 has a first end support 351 and a second end support 352, and a resilient body 355 extending therebetween. The resilient body 355 is in the form of a plurality of elastomeric layers spanning between the end supports 351, 352. Referring to FIG. 40, each end support 351, 352 is in the form of a body 374. Each side of the body 374 incorporates a clip projection 376 extending therefrom. During assembly each clip projection 376 is caused to align and engage with a corresponding clip recess 378 in the end face of the clamping device for releasable engagement therewith.

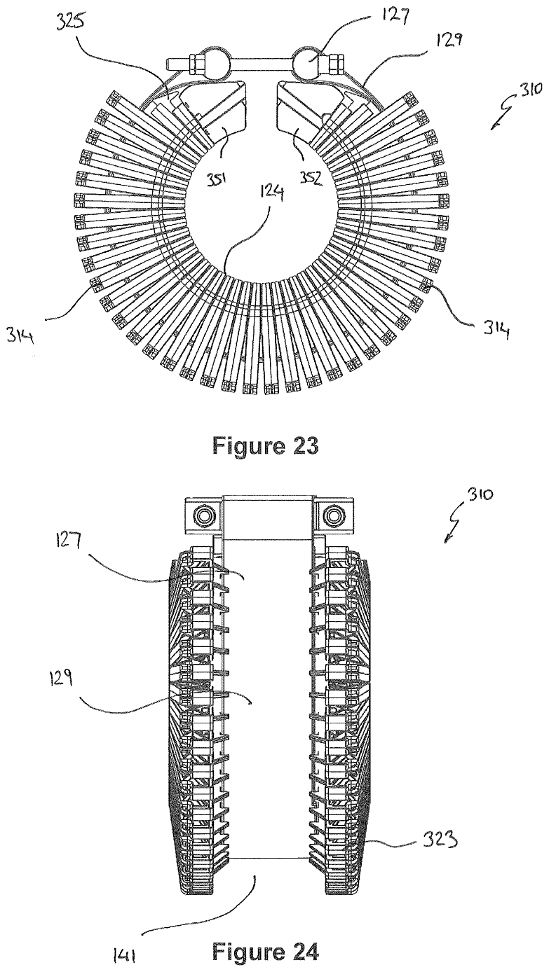

The clamp elements 314 co-operate with the resilient ring 325 to retain the clamp elements in a circular arrangement. In particular, an engaging surface 365 of each of the first end support 351 and the second end support 352 engage respectively a first end clamp element 343 and a second end clamp element 345, as best shown in FIG. 23.

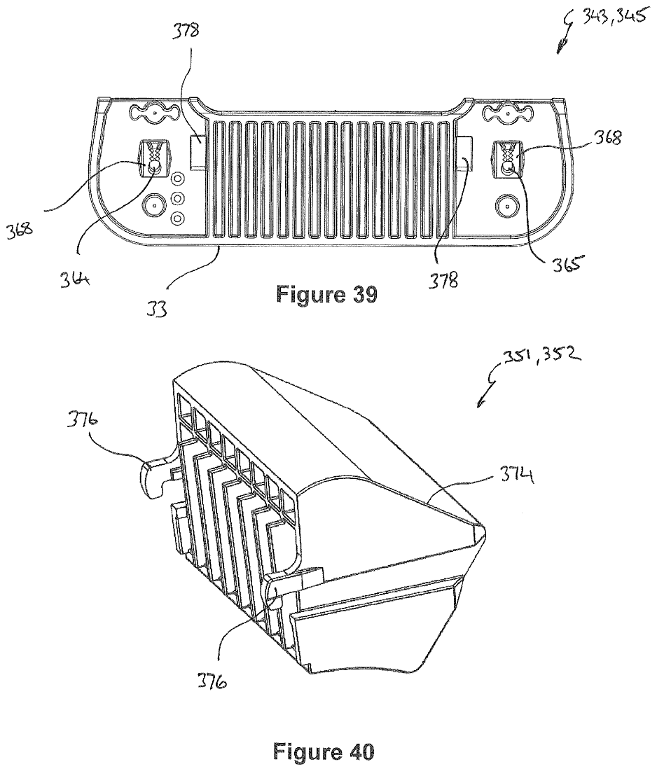

As best shown in FIG. 39, in this embodiment the first end and second end clamp elements 343, 345 are shorter in length than the standard clamp elements 314, while the clamp elements directly adjacent the first end and second end clamp elements 343, 345 are of a length between the end clamp elements 343, 345 and the standard the clamp elements 314. This difference provides clearance to operate equipment when securing the clamp assembly 310 to a riser.

As best shown in FIGS. 33 to 36, the clamp assembly 310 incorporates a support device in the form of two annular rings 380. Each annular ring 380 is located below sidewall projections 312 in the recess 341, with one positioned either side of the resilient ring 325. Each annular ring 380 is formed from a resiliently deformable material which is able to support the resilient ring 325, such as when the clamp assembly 310 is stored or being transported in a non-vertical orientation, so as to keep the resilient ring 325 in a relatively central position. The resiliently deformable material must also be capable of deforming such that any lateral force exerted thereon by the resilient ring 325 is not hindered by the annular ring 380.

Modifications and variations such as would be apparent to the skilled addressee are considered to fall within the scope of the present invention. Such variations are not to be regarded as a departure from the disclosure, and all such modifications are intended to be included within the scope of the disclosure.

The present invention is not to be limited in scope by any of the specific embodiments described herein. These embodiments are intended for the purpose of exemplification only. Functionally equivalent products, formulations and methods are clearly within the scope of the invention as described herein. It will be understood by those skilled in the art that various changes in form and details may be made therein without departing from the spirit and scope of the invention as defined by the appended claims.

Reference to positional descriptions and spatially relative terms), such as “inner,” “outer,” “beneath”, “below”, “lower”, “above”, “upper” and the like, are to be taken in context of the embodiments depicted in the figures, and are not to be taken as limiting the invention to the literal interpretation of the term but rather as would be understood by the skilled addressee.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprise”, “comprises,” “comprising,” “including,” and “having,” or variations thereof are inclusive and therefore specify the presence of stated features, integers, steps, operations, elements, and/or components, but do not preclude the presence or addition of one or more other features, integers, steps, operations, elements, components, and/or groups thereof.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

1-76. (canceled)

77. A clamp assembly which is adapted to be fitted to an external surface of a riser, the clamp assembly is movable between a first condition wherein the clamp assembly can be fitted or removed from the riser, and a second condition wherein the clamp assembly is secured to the riser, the clamp assembly comprises:
a multi-element subassembly in an annular configuration, the multi-element subassembly provides an inner clamping face which, in use, is adapted to engage the external surface of the riser, the multi-element subassembly also provides a recess in an outer face;
a strap tensioning assembly received in the recess, the strap tensioning assembly facilitates movement of the clamp assembly between the first condition and the second condition; and
a compliant ring received in the recess, the compliant ring co-operates with the strap tensioning assembly and the multi-element subassembly wherein the compliant ring accommodates variations in the diameter of the inner clamping face of the multi-element subassembly when the clamp assembly is in the second condition.

78. A clamp assembly which is adapted to be fitted to an external surface of a riser, the clamp assembly is movable between a first condition wherein the clamp assembly can be fitted or removed from the riser, and a second condition wherein the clamp assembly is secured to the riser, the clamp assembly comprises:
a clamping device of annular configuration, the clamping device provides an inner clamping face which, in use, is adapted to engage the external surface of the riser, and a recess in an outer face;
a fastening means received in the recess, the fastening means facilitates movement of the clamp assembly between the first condition and the second condition; and
a resilient means which co-operates with the fastening means and the clamping device wherein the resilient means is received in the recess and accommodates variations in the diameter of the inner clamping face of the clamping device when the clamp assembly is in the second condition.

79. The clamp assembly according to claim 78 wherein the clamping device has a first end spaced from a second end such that the clamping device is not a complete annulus, the clamping device is in the form of a multi-element subassembly.

80. The clamp assembly according to claim 78 wherein the fastening means is in the form of a strap tensioning assembly.

81. The clamp assembly according to claim 78 wherein the resilient means is in the form of a compliant ring, wherein the compliant ring has a first end spaced from a second end such that the compliant ring is not a complete ring.

82. The clamp assembly according to claim 78 wherein the inner clamping face of the clamping device accommodates changes in the diameter of the external surface of the riser.

83. The clamp assembly according to claim 78 wherein the resilient means is in the form of a generally circular resilient ring having a first end support and a second end support, and a resilient body extending therebetween, wherein the first end support and second end support are in a spaced face to face relation, the first end support provides the first end of the resilient ring, and the second end support provides the second end of the resilient ring.

84. The clamp assembly according to claim 83 wherein each of the first end support and the second end support is formed from a plurality of bodies, the plurality of bodies are generally planar in shape and arranged in a face to face relationship extending along an axis substantially parallel to the longitudinal axis of the clamp assembly, the plurality of bodies are secured together.

85. The clamp assembly according to claim 83 wherein each of the first end support and the second end support is formed from a body, each body has one or more clip projections extending therefrom for engagement with a corresponding clip recess in an end face of the clamping device for releasable engagement therewith.

86. The clamp assembly according to claim 83 wherein each of the first end support and the second end support has an upper surface which supports a tensioning assembly of the fastening means, the upper surface supports the tensioning assembly as the clamp assembly moves between the first condition and the second condition.

87. The clamp assembly according to claim 83 wherein the resilient ring comprises an outer surface upon which the fastening means acts, and an inner surface which acts upon the clamp assembly such that the resilient ring is positioned between the fastening means and the clamp assembly.

88. The clamp assembly according to claim 79 wherein the clamping device incorporates a gap between the first end and the second end, wherein the gap is variable based on whether the clamp assembly is in the first condition, the second condition or a condition therebetween.

89. The clamp assembly according to claim 78 wherein the clamping device is formed from a plurality of clamp elements, including a first end clamp element at the first end and a second end clamp element at the second end wherein the gap of the clamping device is formed between the first end clamp element and the second end clamp element wherein a bottom edge of each clamp element co-operates with the bottom edge of adjacent clamp elements to provide the inner clamping face of the clamping assembly.

90. The clamp assembly according to claim 89 wherein each clamp element is U-shaped, wherein each clamp element co-operates with adjacent clamp elements such that the U-shaped clamp elements co-operate to form the recess, wherein the clamping device forms sidewalls on either side of the recess, wherein the sidewalls are provided by the legs of the U-shaped clamp elements.

91. The clamp assembly according to claim 78 wherein the fastening means comprises a ring clamp wherein the ring clamp can be operatively caused to reduce or increase in diameter, whereupon reduction of the ring clamp's diameter the clamp assembly is caused to move towards its second condition, and whereupon increasing the ring clamp's diameter the clamp assembly is able to move to its first condition.

92. The clamp assembly according to claim 78 wherein the clamp assembly comprises a support device adapted to support the resilient means in a substantially central position of the recess, wherein support means ensures the resilient means remains in a substantially central position regardless of the orientation of the clamping assembly.

93. The clamp assembly according to claim 92 wherein the support device comprises a resiliently deformable material located in the recess and is located between the resilient means and the sidewall, wherein the support device is located below projections extending from the sidewalls.

94. The clamp assembly according to claim 92 wherein the support device is in the form of an annular ring located either side of the resilient means.

95. A clamp assembly, the clamp assembly is movable between a first condition wherein the clamp assembly can be fitted to or removed from a riser, and a second condition wherein the clamp assembly is secured to the riser, the clamp assembly comprises:
a clamping device having an inner clamping face which, in use, is adapted to engage the external surface of the riser, and a recess in an outer face;
a ring clamp received in the recess, the ring clamp facilitates movement of the clamp assembly between the first condition and the second condition; and
a circular resilient ring received in the recess which co-operates with the ring clamp and the clamping device wherein the circular resilient ring accommodates variations in the diameter of the inner clamping face of the clamping device when the clamp assembly is in the second condition.

96. The clamp assembly according to claim 95 wherein the resilient ring is positioned in the recess between the fastening means and the clamping device.

97. A buoyancy assembly adapted to be fitted to a riser to assist in supporting the riser, the buoyancy assembly comprising a clamp assembly according to claim 78.
